(19) United States
(12) Patent Application Publication
(10) Pub. No.: US 2018/0039643 A1
(43) Pub. Date: Feb. 8, 2018

(54) ANALYSIS AND MANAGEMENT OF RESOURCES IN A NETWORK

(71) Applicant: Searchmetrics GmbH, Berlin (DE)

(72) Inventors: Marcus Tober, Berlin (DE); Stephan Sommer-Schulz, Falkensee (DE); Christian Lange, Berlin (DE); Robert Dittrich, Berlin (DE)

(73) Assignee: Searchmetrics GmbH, Berlin (DE)

(21) Appl. No.: 15/226,074

(22) Filed: Aug. 2, 2016

(51) Int. Cl. G06F 17/30; H04L 12/24

(52) U.S. Cl. CPC G06F 17/3089; H04L 41/14; G06F 17/30867; H04L 67/02

(57) ABSTRACT

A computer-implemented method analyzes resources in a network. An analyzer executing on one or more computing devices receives an input having one or more identifiers to one or more target resources in the network. The analyzer also receives one or more values for one or more performance metrics relevant to the one or more target resources. The analyzer automatically uses pre-stored performance metrics to prepare one or more rankings of performance for the one or more target resources and one or more field resources based on the one or more performance metrics. The analyzer automatically uses the prepared one or more rankings to identify, from one or more target resources, one or more identified target resources having a performance potential higher than remaining target resources of the one or more target resources, a corresponding system, computing device, and non-transitory computer-readable storage medium.

### BACKGROUND OF THE INVENTION

### Field of the Invention

The invention relates to a method, system, computing device and storage medium for managing resources in a network. More specifically, the invention relates to a method, system, computing device and storage medium for analyzing resources in a network.

### Description of Prior Art

The World-Wide Web (www) comprises an indefinite number of webpages. Search engines crawl the webpages via the Internet and return, for user convenience, a list of webpages relevant to any particular search term, i. e. one or more keywords. Operators aiming to promote their webpages onto these lists of webpages optimize, using various techniques, their webpages for the search engines (search engine optimization, SEO). Recently, access to and usage of the World-Wide Web has moved from stationary personal computers to mobile computing devices.

Owing to the indefinite number of webpages and their ever changing contents, it is increasingly difficult to optimize webpages.

The present invention overcomes present limitations and provides other advantages, as will become clearer to those skilled in the art from the present description.

### BRIEF SUMMARY OF THE INVENTION

According to an aspect of an embodiment, a computer-implemented method of analyzing resources in a network may comprise: at an analyzer executing on one or more computing devices, receiving an input comprising: one or more identifiers to one or more target resources in the network, and one or more values for one or more performance metrics relevant to the one or more target resources; automatically, with the analyzer using pre-stored performance metrics, preparing one or more rankings of performance for the one or more target resources, and one or more field resources based on the one or more performance metrics; and automatically, with the analyzer using the prepared one or more rankings, identifying, from one or more target resources, one or more identified target resources having a performance potential higher than remaining target resources of the one or more target resources.

According to an aspect of another embodiment, in a method, the one or more identifiers may comprise at least one of a universal resource locator, a domain name and a subdomain name.

According to an aspect of another embodiment, in a method, the one or more target resources may comprise at least one of a target webpage, a target software application, a target app and a target app store.

According to an aspect of another embodiment, in a method, the one or more field resources may comprise at least one of a field webpage, a field software application, a field app and a field app store.

According to an aspect of another embodiment, a method may further comprise: automatically, with an aggregator executing on one or more computing devices and coupled to the analyzer, aggregating the one or more field resources from one or more resources based on the one or more target resources.

According to an aspect of another embodiment, in a method, the one or more performance metrics may comprise at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate.

According to an aspect of another embodiment, in a method, the one or more performance metrics may comprise one or more context-related performance metrics relating to one or more contextual networks.

According to an aspect of another embodiment, in a method, preparing the one or more rankings may comprise: averaging the pre-stored performance metrics.

According to an aspect of another embodiment, in a method, preparing the one or more rankings may comprise: weighting the pre-stored performance metrics.

According to an aspect of another embodiment, in a method, the one or more rankings may relate to one or more subnetworks.

According to an aspect of another embodiment, a method may further comprise: automatically, with the analyzer, clustering two or more rankings of the prepared one or more rankings into a clustered ranking.

According to an aspect of another embodiment, a method may further comprise: automatically, with the analyzer, clustering two or more identifiers of the one or more identifiers into clustered identifiers based on the one or more performance metrics.

According to an aspect of another embodiment, a method may further comprise: automatically, with the analyzer, comparing the one or more identified target resources with the one or more field resources.

According to an aspect of another embodiment, a method may further comprise: automatically, with a crawler executing on one or more computing devices, crawling the network and acquiring contents from one or more resources in the network; automatically, with a determiner executing on the one or more computing devices and coupled to the crawler, determining performance metrics characterizing each of one or more resources of the crawled network; and automatically, with a data base executing on the one or more computing devices and coupled to the determiner, storing the determined performance metrics as the pre-stored performance metrics.

According to an aspect of another embodiment, in a method may further comprise: automatically, with a generator executing on one or more computing devices and coupled to the analyzer, generating an output comprising: the one or more identified target resources.

According to an aspect of another embodiment, in a method may further comprise: with an optimizer executing on one or more computing devices and coupled to the analyzer, optimizing the one or more identified target resources.

According to an aspect of yet another embodiment, a system for analyzing resources in a network may comprise: an analyzer, when executing on one or more computing devices: receiving an input comprising: one or more identifiers to one or more target resources in the network, and one or more values for one or more performance metrics relevant to the one or more target resources; automatically, using pre-stored performance metrics, preparing one or more rankings of performance for the one or more target resources, and one or more field resources based on the one or more performance metrics; and automatically, using the prepared one or more rankings, identifying, from one or more target resources, one or more identified target resources having a performance potential higher than remaining target resources of the one or more target resources.

According to an aspect of another embodiment, in a system, the one or more identifiers may comprise at least one of a universal resource locator, a domain name and a subdomain name.

According to an aspect of another embodiment, in a system, the one or more target resources may comprise at least one of a target webpage, a target software application, a target app and a target app store.

According to an aspect of another embodiment, in a system, the one or more field resources may comprise at least one of a field webpage, a field software application, a field app and a field app store.

According to an aspect of another embodiment, a system may further comprise: an aggregator, when executing on the one or more computing devices: being coupled to the analyzer; and automatically aggregating the one or more field resources from one or more resources based on the one or more target resources.

According to an aspect of another embodiment, in a system, the one or more performance metrics may comprise at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate.

According to an aspect of another embodiment, in a system, the one or more performance metrics may comprise one or more context-related performance metrics relating to one or more contextual networks.

According to an aspect of another embodiment, in a system, preparing the one or more rankings may comprise: averaging the pre-stored performance metrics.

According to an aspect of another embodiment, in a system, preparing the one or more rankings may comprise: weighting the pre-stored performance metrics.

According to an aspect of another embodiment, in a system, the one or more rankings may relate to one or more subnetworks.

According to an aspect of another embodiment, in a system, the analyzer, when executing on the one or more computing devices, may further: automatically cluster two or more rankings of the prepared one or more rankings into a clustered ranking.

According to an aspect of another embodiment, in a system, the analyzer, when executing on the one or more computing devices, may further: automatically cluster two or more identifiers of the one or more identifiers into clustered identifiers based on the one or more performance metrics.

According to an aspect of another embodiment, in a system, the analyzer, when executing on the one or more computing devices, may further: automatically compare the one or more identified target resources with the one or more field resources.

According to an aspect of another embodiment, a system may further comprise: a crawler, when executing on the one or more computing devices: automatically crawling the network and acquiring contents from one or more resources in the network; a determiner, when executing on the one or more computing devices: being coupled to the crawler; and automatically determining performance metrics characterizing each of one or more resources of the crawled network; and a data base, when executing on the one or more computing devices: being coupled to the determiner; and automatically storing the determined performance metrics as the pre-stored performance metrics.

According to an aspect of another embodiment, in a system may further comprise: a generator, when executing on the one or more computing devices may: be coupled to the analyzer; and automatically generate an output comprising: the one or more identified target resources.

According to an aspect of another embodiment, a system may further comprise: an optimizer, when executing on the one or more computing devices: being coupled to the analyzer; and optimizing the one or more identified target resources.

According to an aspect of yet another embodiment, a computing device for analyzing resources in a network may comprise: one or more processors, configured to perform operations; and a memory, coupled to the one or more processors and comprising: an analyzer, when executing the one or more processors: receiving an input comprising: one or more identifiers to one or more target resources in the network, and one or more values for one or more performance metrics relevant to the one or more target resources; automatically, using pre-stored performance metrics, preparing one or more rankings of performance for the one or more target resources, and one or more field resources based on the one or more performance metrics; and automatically, using the prepared one or more rankings, identifying, from one or more target resources, one or more identified target resources having a performance potential higher than remaining target resources of the one or more target resources.

According to an aspect of another embodiment, in a computing device, the one or more identifiers may comprise at least one of a universal resource locator, a domain name and a subdomain name.

According to an aspect of another embodiment, in a computing device, the one or more target resources may comprise at least one of a target webpage, a target software application, a target app and a target app store.

According to an aspect of another embodiment, in a computing device, the one or more field resources may comprise at least one of a field webpage, a field software application, a field app and a field app store.

According to an aspect of another embodiment, in a computing device, the memory may further comprise: an aggregator, when executing on the one or more processors: being coupled to the analyzer; and automatically aggregating the one or more field resources from one or more resources based on the one or more target resources.

According to an aspect of another embodiment, in a computing device, the one or more performance metrics may comprise at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate.

According to an aspect of another embodiment, in a computing device, the one or more performance metrics may comprise one or more context-related performance metrics relating to one or more contextual networks.

According to an aspect of another embodiment, in a computing device, preparing the one or more rankings may comprise: averaging the pre-stored performance metrics.

According to an aspect of another embodiment, in a computing device, preparing the one or more rankings may comprise: weighting the pre-stored performance metrics.

According to an aspect of another embodiment, in a computing device, the one or more rankings may relate to one or more subnetworks.

According to an aspect of another embodiment, in a computing device, the analyzer, when executing on the one or more processors, may further: automatically cluster two or more rankings of the prepared one or more rankings into a clustered ranking.

According to an aspect of another embodiment, in a computing device, the analyzer, when executing on the one or more processors, may further: automatically cluster two or more identifiers of the one or more identifiers into clustered identifiers based on the one or more performance metrics.

According to an aspect of another embodiment, in a computing device, the analyzer, when executing on the one or more processors, may further: automatically compare the one or more identified target resources with the one or more field resources.

According to an aspect of another embodiment, in a computing device, the memory may further comprise: a crawler, when executing on the one or more processors: automatically crawling the network and acquiring contents from one or more resources in the network; a determiner, when executing on the one or more processors: being coupled to the crawler; and automatically determining performance metrics characterizing each of one or more resources of the crawled network; and a data base, when executing on the one or more processors: being coupled to the determiner; and automatically storing the determined performance metrics as the pre-stored performance metrics.

According to an aspect of another embodiment, in a computing device, the memory may further comprise: a generator, when executing on the one or more processors: being coupled to the analyzer; and automatically generating an output comprising: the one or more identified target resources.

According to an aspect of another embodiment, in a computing device, the memory may further comprise: an optimizer, when executing on the one or more processors: being coupled to the analyzer; and optimizing the one or more identified target resources.

According to an aspect of yet another embodiment, a non-transitory computer-readable storage medium may comprise instructions causing a system to perform operations for analyzing resources in a network, and the operations may comprise: receiving an input comprising: one or more identifiers to one or more target resources in the network, and one or more values for one or more performance metrics relevant to the one or more target resources; automatically, using pre-stored performance metrics, preparing one or more rankings of performance for the one or more target resources, and one or more field resources based on the one or more performance metrics; and automatically, using the prepared one or more rankings, identifying, from one or more target resources, one or more identified target resources having a performance potential higher than remaining target resources of the one or more target resources.

According to an aspect of another embodiment, in a storage medium, the one or more identifiers may comprise at least one of a universal resource locator, a domain name and a subdomain name.

According to an aspect of another embodiment, in a storage medium, the one or more target resources may comprise at least one of a target webpage, a target software application, a target app and a target app store.

According to an aspect of another embodiment, in a storage medium, the one or more field resources may comprise at least one of a field webpage, a field software application, a field app and a field app store.

According to an aspect of another embodiment, in a storage medium, the operations may further comprise: automatically aggregating the one or more field resources from one or more resources based on the one or more target resources.

According to an aspect of another embodiment, in a storage medium, the one or more performance metrics may comprise at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate.

According to an aspect of another embodiment, in a storage medium, the one or more performance metrics may comprise one or more context-related performance metrics relating to one or more contextual networks.

According to an aspect of another embodiment, in a storage medium, preparing the one or more rankings may comprise: averaging the pre-stored performance metrics.

According to an aspect of another embodiment, in a storage medium, preparing the one or more rankings may comprise: weighting the pre-stored performance metrics.

According to an aspect of another embodiment, in a storage medium, the one or more rankings may relate to one or more subnetworks.

According to an aspect of another embodiment, in a storage medium, the operations may further comprise: automatically clustering two or more rankings of the prepared one or more rankings into a clustered ranking.

According to an aspect of another embodiment, in a storage medium, the operations may further comprise: automatically clustering two or more identifiers of the one or more identifiers into clustered identifiers based on the one or more performance metrics.

According to an aspect of another embodiment, in a storage medium, the operations may further comprise: automatically comparing the one or more identified target resources with the one or more field resources.

According to an aspect of another embodiment, in a storage medium, the operations may further comprise: automatically crawling the network and acquiring contents from one or more resources in the network; automatically determining performance metrics characterizing each of one or more resources of the crawled network; and automatically storing the determined performance metrics as the pre-stored performance metrics.

According to an aspect of another embodiment, in a storage medium, the operations may further comprise: automatically generating an output comprising: the one or more identified target resources.

According to an aspect of another embodiment, in a storage medium, the operations may further comprise: optimizing the one or more identified target resources.

According to an aspect of yet another embodiment, a computer-implemented method of managing resources in a network may comprise: automatically analyzing performance potentials of the resources based on performance metrics of the resources; automatically identifying a resource having a highest performance potential of the performance potentials; and for increasing performance metrics of the identified resource, effecting modification of the identified resource.

According to an aspect of another embodiment, a method may further comprise: repeating said analyzing, identifying and effecting.

According to an aspect of yet another embodiment, a system of managing resources in a network may comprise: a manager, when executing on one or more computing devices: automatically analyzing performance potentials of the resources based on performance metrics of the resources; automatically identifying a resource having a highest performance potential of the performance potentials; and for increasing performance metrics of the identified resource, effecting modification of the identified resource.

According to an aspect of another embodiment, in a system, the manager, when executing on one or more computing devices may repeat said analyzing, identifying and effecting.

According to an aspect of yet another embodiment, a computing device for managing resources in a network may comprise: one or more processors, configured to perform operations; and a memory, coupled to the one or more processors and comprising: a manager, when executing the one or more processors: automatically analyzing performance potentials of the resources based on performance metrics of the resources; automatically identifying a resource having a highest performance potential of the performance potentials; and for increasing performance metrics of the identified resource, effecting modification of the identified resource.

According to an aspect of another embodiment, in a computing device, the manager, when executing on the one or more processors, may further: repeat said analyzing, identifying and effecting.

According to an aspect of yet another embodiment, a non-transitory computer-readable storage medium may comprise instructions causing a system to perform operations for analyzing resources in a network, and the operations may comprise: automatically analyzing performance potentials of the resources based on performance metrics of the resources; automatically identifying a resource having a highest performance potential of the performance potentials; and for increasing performance metrics of the identified resource, effecting modification of the identified resource.

According to an aspect of another embodiment, in a storage medium, the operations may further comprise: repeating said analyzing, identifying and effecting.

Analyzing and managing resources in a network are challenges particular to the Internet. The present invention can enable a user, for example an operator of a large number of resources such as webpages, to determine a present performance of a resource. Moreover, it can enable the user to determine a potential of the resource. Thus, the present invention can enable the user to cope with the analysis and management of the resources although technical, administrative or financial means may be limited. Further, the present invention can enable the user to concentrate on the resource within the large number of resources having best prospects. Furthermore, the present invention can enable the user to save time or to reduce costs.

The object and advantages of the embodiments will be realized and achieved at least by steps, elements, features and combinations defined in the claims. Thus, this brief summary and the following detailed description are exemplary and explanatory, and are not restrictive of the invention as defined in the claims.

### BRIEF DESCRIPTION OF THE SEVERAL VIEWS OF THE DRAWING

The enclosed drawing depicts various aspects of some embodiments, and is not restrictive of the invention as defined in the claims:

FIG. 1 shows a typical computer network architecture 1 implementing the present invention;

FIG. 2 shows a typical computer device architecture 10 implementing the present invention;

FIG. 3 shows typical search engine results 2 implementing the present invention;

FIG. 4 shows a resource management architecture 3 implementing the present invention;

FIG. 5 shows a flow chart of a pre-process 4 for analyzing resources in a network according to an embodiment of the present invention;

FIG. 6 shows a flow chart of a process 5 for analyzing resources in a network according to an embodiment of the present invention;

FIG. 7 shows a flow chart of a process 6 for managing resources in a network according to an embodiment of the present invention; and

FIG. 8 shows a flow chart of another process 7 for analyzing resources in a network according to another embodiment of the present invention.

### DETAILED DESCRIPTION OF THE INVENTION

A preferred embodiment of the invention is now described in detail. Referring to the drawing, like reference numbers indicate like parts throughout the views. The drawing shows diagrammatic and schematic representations of some embodiments, is not necessarily drawn to scale, and is not restrictive of the invention. As used in the description and claims, the meaning of “a”, “an” and “the” includes plural reference unless the context clearly dictates otherwise.

As used herein, the term “computer network” generally refers to a plurality of interconnected computing devices such as desktop computers, laptop computers, mobile devices like tablet computers, smart phones and smart watches, and servers, interconnected directly or, via network devices such as hubs, routers, switches and gateways, indirectly, for example the Internet. The computer network may comprise wire-based or wireless connections, or both.

As used herein, the term “resource” generally refers to an information source, for example a document such as a static document like hypertext markup language (html) document or dynamically generated document like PHP: Hypertext Preprocessor (php) document, or a software application, such as a software application for a mobile device (mobile app, app), located in one or more computing devices and being accessible, using an identifier of the resource, via the computer network. The term target resource generally refers to a resource under test, whereas the term field resource generally refers to a resource serving as reference.

As used herein, the term “universal resource locator (URL)” generally refers to an identifier to the resource, specifying its location on the computer network and a mechanism for retrieving it.

As used herein, the term “page” generally refers to a single-page resource. Pages may have different lengths.

As used herein, the term “webpage” generally refers to a page in the World-Wide Web (www).

As used herein, the term “site” generally refers a plurality of pages accessible via a common domain or subdomain name. Sites are typically operated by companies, governments, organizations, and private individuals, for example. The term target site generally refers to a site under test, whereas the term field site generally refers to a site serving as reference.

As used herein, the term “website” generally refers to a site in the World-Wide Web.

As used herein, the term “network” generally refers to a plurality of resources made available to users via a computer network. The World-Wide Web, for example, is a network.

As used herein, the term “keyword” generally refers to a term capturing the essence of a topic of interest or topic of a resource. The term commercial keyword generally refers to a type of keyword having a high probability of bringing prospect customers to a page or site. The term transactional keyword generally refers to a type of keyword, like “buy” and “subscribe”, having a high probability of bringing determined customers to a page or site. The term informational keyword generally refers to a type of keyword, like “what” or “how”, indicating search for information and having a low probability of generating revenue. The term navigational keyword generally refers to a type of keyword, like a company or brand name, indicating a navigational search for merely finding the page or site of this company or product.

As used herein, the term “topic cluster” generally refers to a cluster of similar keywords. The name of a topic cluster may result from the most frequent keyword in a cluster of similar keywords.

As used herein, the term “organic search” generally refers to searching, in response to a query comprising one or more keywords (keyword query), relevant information. A search usually comprises adding attribution information, then filtering it, and then sorting it. Search algorithms comprise the CheiRank (sorting) algorithm and PageRank (sorting) algorithm. The results of the organic search are generally ranked by relevance to the query.

As used herein, the term “search engine” generally refers to a software application for searching information on a network using organic search. Search engines include Google.com, Baidu.com and Yandex.com.

As used herein, the term “crawler” generally refers to a software application executable on a computing device for systematically browsing a network, typically for indexing sites for a search engine.

As used herein, the term “browser” generally refers to a software application executable on a computing device for enabling a computer user to navigate, or surf, a network.

As used herein, the term “search engine results page(s) (SERP(s))” generally refers to one or more pages generated by a search engine in response to a query received from a user via a computing device, returned to the computer device and displaying the ranked results in a browser on the computing device. In addition to results of the organic search, the pages typically further comprise sponsored results, i. e. advertisements relating to the query and paid for by advertisers (keyword advertising).

As used herein, the term “search engine marketing (SEM)” generally refers to marketing on search engine results pages, like keyword advertising.

As used herein, the term “cost per click (CPC)” refers to the cost in pay-per-click (PPC) marketing, a type of paid marketing where the advertiser has to pay to the affiliate when the user follows a link in the advertiser's advertisement. The advertisement may be one of the sponsored results, for example.

As used herein, the term “social network” generally refers to a network, like Facebook.com and Twitter.com, enabling its users to upload and consume, hence, share contents like messages, audio contents or video contents. Users may provide feedback on the contents by posting comments and sending social signals, like Facebook's Likes.

As used herein, the term “social media marketing (SMM)” generally refers to marketing on social networks, like viral videos.

As used herein, the term “marketplace” generally refers to a network, like Amazon.com and Tmall.com, offering products and services for rent or sale. Typically, a marketplace comprises a plurality of resources, each of which being dedicated to one or more products or services. Thus, a marketplace, for example, may comprise hundreds, thousands or millions of resources.

As used herein, the term “video platform” generally refers to a network, like Youtube.com and Vimeo.com, enabling its users to upload and consume, and, hence, share video contents.

As used herein, the term app store generally refers to a network, like Apple's iTunes App Store and Google's Play Store, enabling developers to distribute their software applications for computer devices, for example mobile apps.

As used herein, the term “link building” generally refers to methods aiming to increase the number and quality links on pages pointing to the page or site.

As used herein, the term “search engine optimization (SEO)” generally refers to methods aiming to improve the position of a page or site in the ranked results. The methods include direct on-page optimization amending the page or site itself, and indirect off-page optimization including link building, search engine marketing, social media marketing.

As used herein, the term “contextual network”, or content network, generally refers to a subnetwork of related resources in a network, the subnetwork providing services, like search engines, or contents, like social networks, marketplaces, video platforms and app stores. Typically, contextual networks, like Google AdWords and Facebook Ads, place context-specific advertisement across their pages.

As used herein, the term “performance” generally refers to a network-specific resource and its utility, usefulness and, hence, score and ranking. The performance of a target resource may be represented relative to the performance of a field resource.

As used herein, the term “performance metrics” generally refers to a network-specific resource and its metrics. The term keyword-related performance metrics generally refers to a metrics relating to a keyword, like search volume of the keyword and cost-per-click of the keyword. The term traffic-related performance metrics generally refers to a metrics relating to traffic, like traffic volume of the resource and traffic speed of the resource. The term context-related performance metrics generally refers to a metrics relating to a contextual network, like volume of social signals.

As used herein, the term “performance potential”, or “potential performance”, generally refers to a network-specific resource and its ability to increase its utility and usefulness, and to climb in scores and rankings. Thus, a resource being already at the top of a ranking or most popular has no potential to climb further. The performance potential of a target resource may be represented relative to the performance of a field resource.

For analyzing resources such as electronic resources or digital resources like webpages, software applications, apps and app stores in a network such as the www, a computer such as a server computer coupled to the network may comprise a processor such as microprocessor, configured to perform operations; and a memory such as main memory, coupled to the processor and comprising instructions such as machine instructions. The instructions, when executed in the computer, i. e. by the processor, may cause the operations of crawling the network and acquiring contents from the resources in the network; determining performance metrics, such as keywords, search volumes of the keywords, costs-per-click of the keywords, traffics volumes of the resources, traffic speeds of the resources, context-related performance metrics relating contextual networks such as social networks like Facebook.com and marketplace like Amazon.com, volumes of social signals of the resources, numbers of backlinks to the resources, ratings of the resources, search-engine-optimization values of the resources, and bounce rates and click-through rates, characterizing the resources; and storing the performance metrics in the memory, for example in a data base in the memory.

The instructions may cause the operations of receiving, for example from a user via a web browser on another computer such as client computer, an input comprising an identifier such as a web address, url, domain name and subdomain name to resources under test and a value for a performance metrics relevant to the resources, such as a keyword, aggregating comparative resources based on the resources under test; clustering identifiers into clustered identifiers based on the performance metrics; preparing, for example by averaging or weighting the performance metrics, rankings of performance for the resource and comparative resources based the performance metrics; clustering the rankings into a clustered ranking; and identifying, from the rankings or clustered ranking, resources under test having a higher potential to improve their positions in search results of a search engine than remaining resources under test. The rankings may relate to a subnetwork like a contextual network such as a social network like Facebook.com or a marketplace like Amazon.com.

The instructions may cause the operations of comparing the identified resources with the comparative resources; and generating an output comprising the identified resources. The output may be arranged in a table comprising performance metrics such as generally important performance metrics, dominant performance metrics and user-selected performance metrics. The performance metrics may be suitably represented, for example, as bar graphs, pie charts, bubble charts, traffic-light rating like red amber green (RAG) rating or any combination thereof. The output may be presented to the user via the web browser on the other computer.

The instructions may cause the operations of optimizing the identified resources. The resources may be optimized automatically, semi-automatically or manually.

For managing resources such as electronic resources or digital resources like webpages, software applications, apps and app stores in a network such as the www, a computer such as a server computer coupled to the network may comprise a processor such as microprocessor, configured to perform operations; and a memory such as main memory, coupled to the processor and comprising instructions such as machine instructions. The instructions, when executed in the computer, i. e. by the processor, may cause the operations of analyzing performance potentials of the resources based on their performance metrics; identifying a resource having a highest performance potential of the performance potentials; and effecting modification of the identified resource, and repeating said analyzing, identifying and effecting.

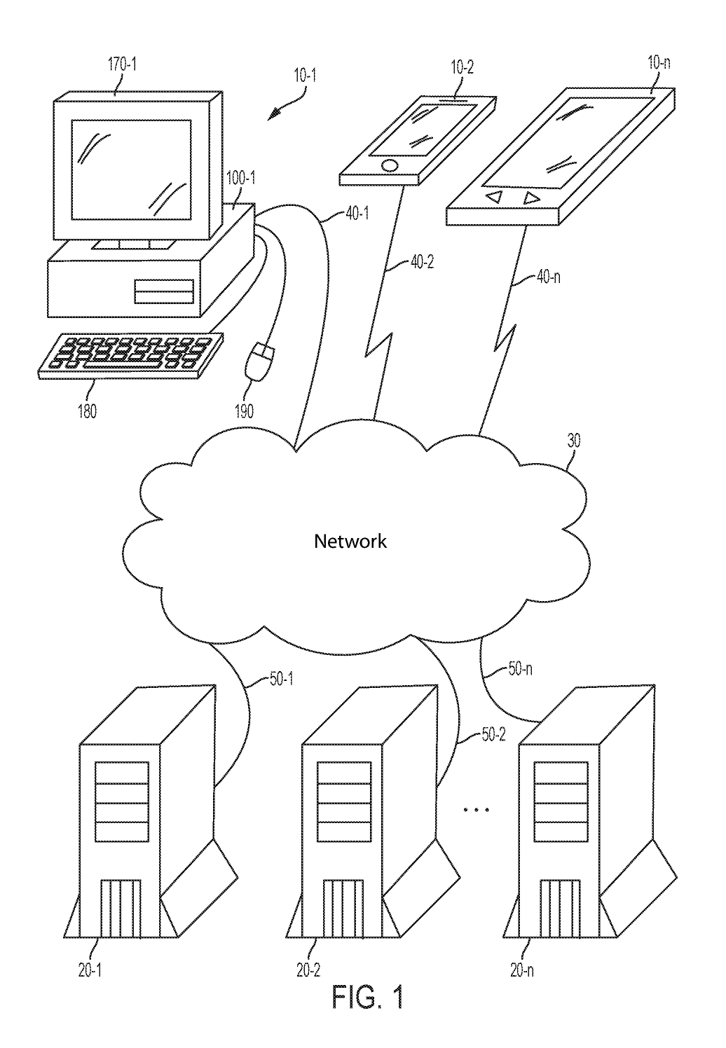

FIG. 1 shows a typical computer network architecture 1 implementing the present invention. The typical computer network architecture 1 may comprise a plurality of client computing devices 10-1, . . . 10-n, a plurality of server computing devices 20-1, . . . 20-n and a network 30 such as the Internet.

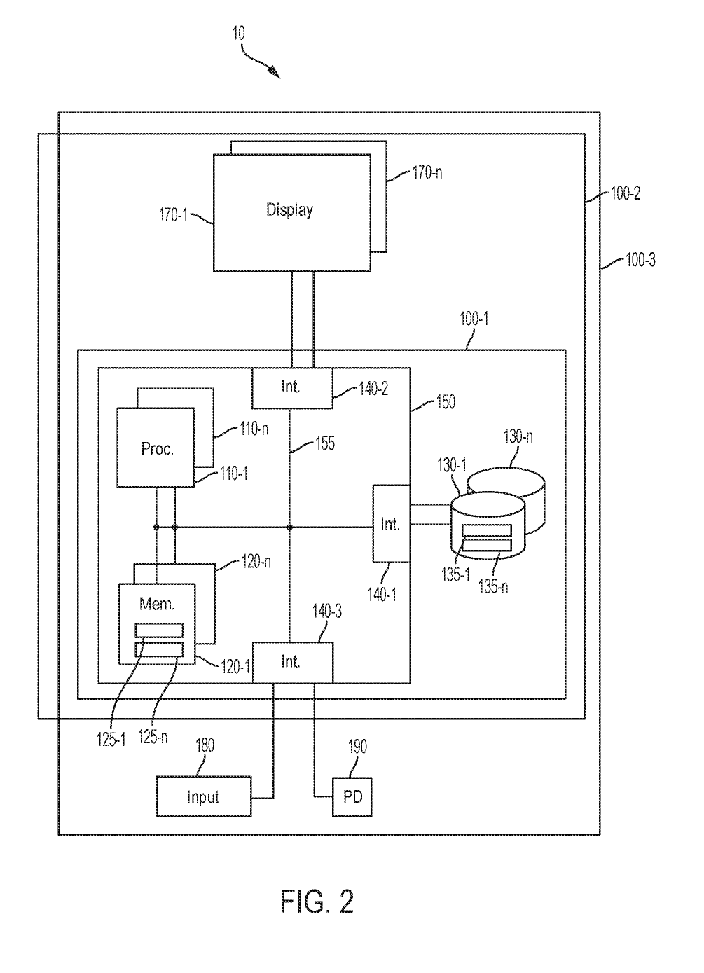

The plurality of client computing devices 10-1, . . . 10-n may comprise one or more stationary computing devices 10-1. One or more of the stationary computing devices 10-1 may, for example, comprise a desktop computer 100-1, a display 170-1 coupled to the desktop computer 100-1, an input device 180 such as a keyboard coupled to the desktop computer 100-1 and a pointing device 190 such as a mouse 190, joystick, trackball and touchpad coupled to the desktop computer 100-1. One or more of the stationary computing devices 10-1 may be coupled to the network 30 via a connection such as wire-based connection 40-1. The plurality of client computing devices 10-1, . . . 10-n may comprise one or more mobile computing devices 10-2, . . . 100-n such as a smart phone 10-2 or a tablet computer 10-n. One or more of the mobile computing devices 10-2, . . . 10-n may be coupled to the network 30 via a connection such as wireless connection 40-1, 40-n. The client computing devices 10-1, . . . 10-n may, for example, be implemented by a typical computer device architecture 10 as described with reference to FIG. 2.

The plurality of server computing devices 20-1, . . . 20-n may, for example, comprise one or more tower servers, one or more rack servers, or any combination thereof. One or more of the plurality of server computing devices 20-1, . . . 20-n may be coupled to the network 30 via a connection such as wire-based connection 50-1, . . . 50-n. The server computing devices 20-1, . . . 20-n may, for example, be implemented by a typical computer device architecture 10 as described with reference to FIG. 2.

The network 30 may comprise one or more hubs, switches, routers and the like. Thus, users of the plurality of client computing devices 10-1, . . . 10-n may, for example, access software such as data or programs stored in plurality of server computing devices 20-1, . . . 20-n via the network 30.

FIG. 2 shows a typical computer device architecture 10 implementing the present invention. The typical computer device architecture 10 may comprise one or more processors 110-1, . . . 110-n, one or more memories 120-1, . . . 120-n coupled to the one or more processors 110-1, . . . 110-n, and one or more interfaces 140-1, . . . 140-3 coupled to the one or more processors 110-1, . . . 110-n.

The one or more processors 110-1, . . . 110-n may execute instructions of programs, for example, comprise a microprocessor, an application-specific integrated circuit (ASIC), an application-specific instruction set processor (ASIP), a digital signal processor (DSP), a co-processor, or any combination thereof. The one or more processors 110-1, . . . 110-n may, for example, comprise a single-core processor, multi-core processor such as quad-core processor, or any combination thereof. The one or more processors 110-1, . . . 110-n may, for example, be implemented by microcontrollers or field programmable gate array (FPGAs).

The one or more memories 120-1, . . . 120-n may store software items 125-1, . . . 125-n such as data or programs likes databases and, for example, comprise volatile memory such as random-access memory (RAM) and static RAM (SRAM), non-volatile memory such as read-only memory (ROM), electrically erasable programmable ROM (EEPROM) and Flash memory, or any combination thereof. The one or more interfaces 140-1, . . . 140-3 may, for example, comprise parallel interfaces, serial interfaces, universal serial bus (USB) interfaces, or any combination thereof.

The one or more processors 110-1, . . . 110-n, one or more memories 120-1, . . . 120-n and one or more interfaces 140-1, . . . 140-3 may be arranged on a circuit board such as printed circuit board (PCB) 150 comprising connections such as a bus 155 coupling the one or more processors 110-1, . . . 110-n, one or more memories 120-1, . . . 120-n and one or more interfaces 140-1, . . . 140-3.

The typical computer device architecture 10 may comprise one or more data storages 130-1, . . . 130-n such as hard disk drives (HDDs, hard disks, hard drives), solid-state drives (SSDs), Compact Disc ROM (CD-ROM) drives, or any combination thereof. The comprise one or more data storages 130-1, . . . 130-n may store software items 135-1, . . . 135-n such as data or programs likes databases. The one or more data storages 130-1, . . . 130-n may, for example, comprise fixed data storages, removable data storages, or any combination thereof. The one or more data storages 130-1, . . . 130-n may be coupled to the one or more processors 110-1, . . . 110-n via a storage interface 140-1 of the one or more interfaces 140-1, . . . 140-3.

The typical computer device architecture 10 may comprise one or more displays 170-1, . . . 170-n such as cathode ray tube (CRT) displays, liquid-crystal displays (LCDs), organic light-emitting diode (OLED) displays, or any combination thereof. The one or more data storages 170-1, . . . 170-n may be coupled to the one or more processors 110-1, . . . 110-n via a display interface 140-2 of the one or more interfaces 140-1, . . . 140-3.

The typical computer device architecture 10 may comprise an input device 180 such as a keyboard coupled to the one or more processors 110-1, . . . 110-n via a input interface 140-3 of the one or more interfaces 140-1, . . . 140-3. The typical computer device architecture 10 may comprise a pointing device 190 such as a mouse, joystick, trackball and touchpad coupled to the one or more processors 110-1, . . . 110-n via the input interface 140-3.

The desktop computer 100-1, for example, may comprise the one or more processors 110-1, . . . 110-n, one or more memories 120-1, . . . 120-n, one or more interfaces 140-1, . . . 140-3, PCB 150 and one or more data storages 130-1, . . . 130-n. An all-in-one computer 100-2, for example, may comprise the one or more processors 110-1, . . . 110-n, one or more memories 120-1, . . . 120-n, one or more interfaces 140-1, . . . 140-3, PCB 150, one or more data storages 130-1, . . . 130-n and one or more displays 170-1, . . . 170-n. A notebook computer 100-3, for example, may comprise the one or more processors 110-1, . . . 110-n, one or more memories 120-1, . . . 120-n, one or more interfaces 140-1, . . . 140-3, PCB 150, one or more data storages 130-1, . . . 130-n, one or more displays 170-1, . . . 170-n, input device 180 and pointing device 190. The typical computer device architecture 10 may further comprise a power supply (not shown) such as mains adapter, battery, or any combination thereof.

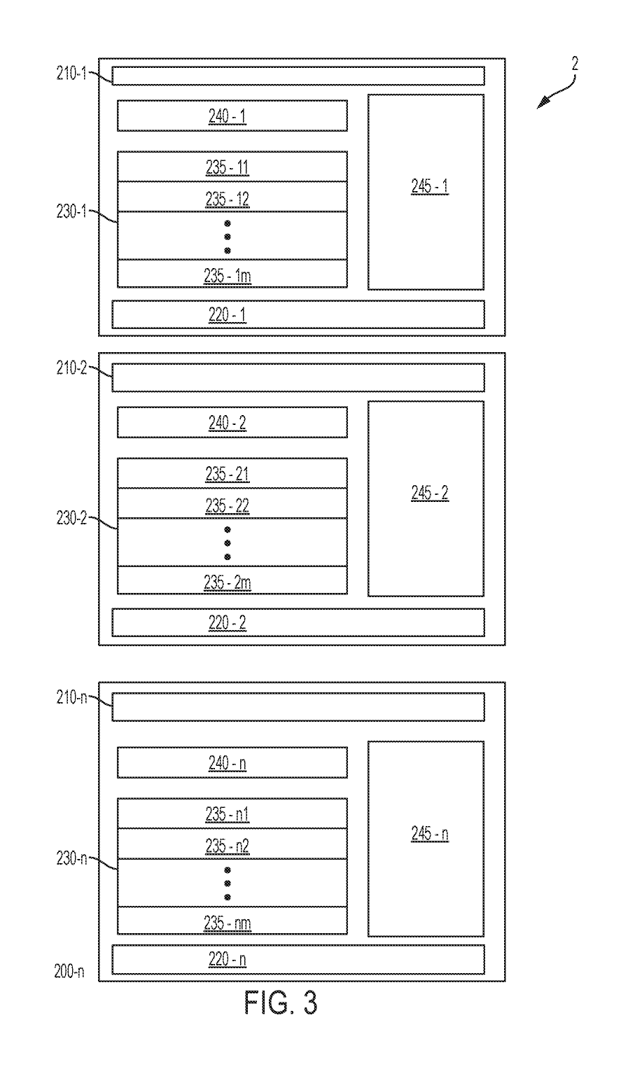

FIG. 3 shows typical search engine results 2 implementing the present invention. The typical search engine results 2 may comprise a plurality of on-screen SERPs 200-1, . . . 200-n comprising a first SERP 200-1, a second SERP 200-2 and subsequent SERP 200-n generated by an search engine.

Each of the plurality of SERPs 200-1, . . . 200-n may comprise a query section 210-1, . . . 210-n for receiving one or more keywords and one or more search instructions from a user. As shown in FIG. 3, the query section 210-1, . . . 210-n may be rectangular. It may extend partially or fully across the SERP 200-1, . . . 200-n. It may be arranged towards a top margin of the SERP 200-1, . . . 200-n.

Each of the plurality of SERPs 200-1, . . . 200-n may comprise a navigation section 220-1, . . . 220-n for receiving navigational instructions from the user, such as a plurality of on-screen buttons each of which being assigned on one of the plurality of SERPs 200-1, . . . 200-n. As shown in FIG. 3, the navigation section 220-1, . . . 220-n may be rectangular. It may extend partially or fully across the SERP 200-1, . . . 200-n. It may be arranged towards a bottom margin of the SERP 200-1, . . . 200-n.

Each of the plurality of SERPs 200-1, . . . 200-n may comprise an organic search result section 230-1, . . . 230-n for displaying one or more organic search results to the user. As shown in FIG. 3, the organic search result section 230-1, . . . 230-n may be rectangular. It may extend partially or fully along the SERP 200-1, . . . 200-n. It may be arranged towards a left margin of the SERP 200-1, . . . 200-n. The organic search result section 230-1, . . . 230-n may comprise a plurality of individual organic search result sections 235-11, . . . 235-1m, 235-21, . . . 235-2m, 235-n1, . . . 235-nm comprising a first individual organic search result section 235-11, 235-21, . . . 235-n1, a second individual organic search result section 235-12, 235-22, . . . 235-n2, and subsequent individual organic search result sections 235-1m, 235-2m, 235-nm. The plurality of organic search result sections 230-1, . . . 230-n may have different numbers m of individual organic search result sections 235-11, . . . 235-1m, 235-21, . . . 235-2m, 235-n1, . . . 235-nm. The search engine may rank the organic search results according to their relevance to the one or more keywords. The search engine may assign to each of the individual organic search result sections 235-11, . . . 235-1m, 235-21, . . . 235-2m, 235-n1, . . . 235-nm one of the organic search results. Thus, a most relevant organic search result may be assigned to the first individual organic search result section 235-11 on the first SERP 200-1, a second most relevant organic search result may be assigned to the second individual organic search result section 235-12 on the first SERP 200-1, an m-th most relevant organic search result may be assigned to the m-th individual organic search result section 235-1m on the first SERP 200-1, an (m+1)-th most relevant organic search result may be assigned to the first individual organic search result section 235-21 on the second SERP 200-2, and so on.

Traffic resulting from searches generally divides into, on the first SERP 200-1, 10% for the most relevant organic search result, 8% for the second most relevant organic search result, 6% for the third most relevant organic search result, 3% for the fourth most relevant organic search result, . . . 0.5% for the tenth most relevant organic search result, on the second SERP 200-2, 0.05% for the eleventh most relevant organic search result.

Performance potentials are generally, on the first SERP 200-1, 0% for both the most relevant organic search result and the second most relevant organic search result, in case of a navigational keyword 0% or in case of a transactional or informational keyword 10% for both the third and fourth most relevant organic search results, 15% for both the fifth and sixth most relevant organic search results, 25% for each of the seventh, eighth, ninth and tenth most relevant organic search results, and on the second SERP 200-2, 500% for both the eleventh and twelfth organic search results, i. e. a move from the second SERP 200-2 to the first SERP 200-1.

Each of the plurality of SERPs 200-1, . . . 200-n may comprise one more sponsored search result sections 240-1, 245-1, . . . 240-n, 245-n for displaying one or more sponsored search results to the user. As shown in FIG. 3, the sponsored search result sections 240-1, 245-1, . . . 240-n, 245-n may be rectangular. They may extend partially or fully along the SERP 200-1, . . . 200-n. A first sponsored search result section 240-1, . . . 240-n may be arranged towards the left margin of the SERP 200-1, . . . 200-n. A second sponsored search result section 245-1, . . . 245-n may be arranged towards the right margin of the SERP 200-1, . . . 200-n.

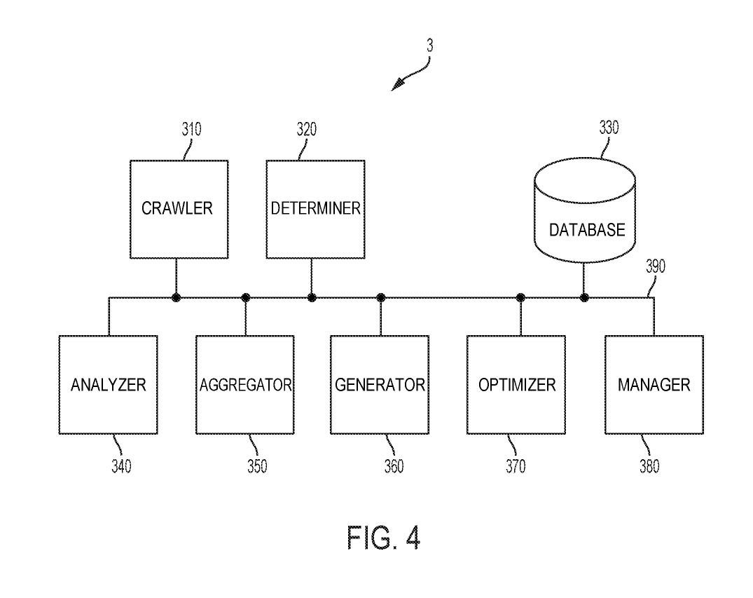

FIG. 4 shows a resource management architecture 3 implementing the present invention. The resource management architecture 3 may, for example, be implemented in a stand-alone resource management system, a content management system (CMS) or research tool, such as online research tool. The resource management architecture 3 may comprise a plurality of modules such as software modules, hardware modules, or any combination thereof. The plurality of modules may be executed on the one or more computing devices 10 such as server computing devices 20-1, . . . 20-n, or provided as a service, that may be implemented as a cloud service. The software modules may comprise programs such as machine code, or compiled or interpreted code. The hardware modules may comprise dedicated hardware such as ASICs and FPGAs. Two or more modules of plurality of modules may be coupled to each other via one or more connections such as a module bus 390.

The resource management architecture 3 may comprise a crawler module 310. The crawler module 310 may automatically crawl a network and acquire contents from one or more resources in the network.

The resource management architecture 3 may comprise a determiner module 320. The determiner module 320 may automatically determine performance metrics characterizing each of one or more resources of the crawled network.

The resource management architecture 3 may comprise a data base module 330. The data base module 330 may automatically store the determined performance metrics as pre-stored performance metrics.

The resource management architecture 3 may comprise an analyzer module 340. The analyzer module 340 may receive an input comprising one or more identifiers to one or more target resources in the network and one or more values for one or more performance metrics relevant to the one or more target resources. The analyzer module 340 may receive the input from a user aiming to analyze the resources in the network. The one or more identifiers may comprise at least one of a universal resource locator, a domain name and a subdomain name. The one or more performance metrics may comprise at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate. The one or more performance metrics may comprise one or more context-related performance metrics relating to one or more contextual networks. The one or more target resources may comprise at least one of a target webpage, a target software application, a target app and a target app store. The analyzer module 340 may automatically cluster two or more identifiers of the one or more identifiers into clustered identifiers based on the one or more performance metrics.

The analyzer module 340 may automatically prepare one or more rankings of performance for the one or more target resources, and one or more field resources based on the one or more performance metrics. Preparing the one or more rankings may comprise averaging the pre-stored performance metrics such as weighting the pre-stored performance metrics. The one or more rankings may relate to one or more subnetworks. The analyzer module 340 may use the pre-stored performance metrics. The analyzer module 340 may automatically cluster two or more rankings of the prepared one or more rankings into a clustered ranking.

The analyzer module 340 may automatically identify from one or more target resources, one or more identified target resources having a performance potential higher than remaining target resources of the one or more target resources. The analyzer module 340 may use the prepared one or more rankings. The one or more field resources may comprise at least one of a field webpage, a field software application, a field app and a field app store. The analyzer module 340 may automatically compare the one or more identified target resources with the one or more field resources.

The resource management architecture 3 may comprise an aggregator module 350. The aggregator module 350 may automatically aggregate the one or more field resources from one or more resources based on the one or more target resources.

The resource management architecture 3 may comprise a generator module 360. The generator module 360 may automatically generate an output. The output may comprise the one or more identified target resources.

The resource management architecture 3 may comprise an optimizer module 370. The optimizer module 370 may optimize the one or more identified target resources.

The resource management architecture 3 may comprise a manager module 380. The manager module 380 may automatically analyze performance potentials of the resources based on performance metrics of the resources. The manager module 380 may automatically identify a resource having a highest performance potential of the performance potentials. The manager module 380 may effect modification of the identified resource. Thus, the manager module 380 may increase performance metrics of the identified resource.

The manager module 380 may repeat said analyzing, identifying and effecting. The, The manager module 380 may iteratively increase performance metrics of a plurality of identified resources.

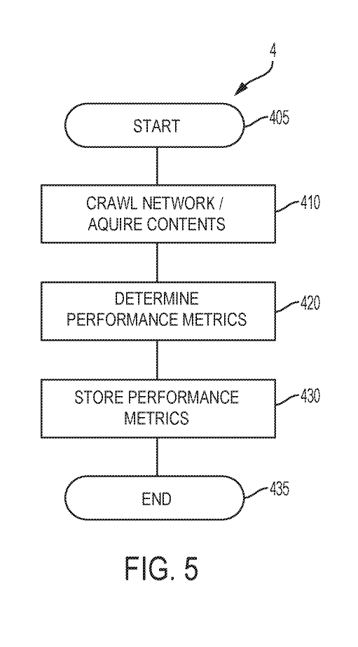

FIG. 5 shows a flow chart of a pre-process 4 for analyzing resources in a network according to an embodiment of the present invention. The pre-process 4 obtains performance metrics and stores same for subsequent analysis of the resources in the network.

The pre-process 4 for analyzing the resources in the network starts at step 405.

Following step 405, the pre-process 4 comprises step 410. In step 410, the pre-process 4 may automatically crawl the network and acquire contents from one or more resources in the network.

Following step 410, the pre-process 4 comprises step 420. In step 420, the pre-process 4 may automatically determine performance metrics characterizing each of one or more resources of the crawled network.

Following step 420, the pre-process 4 comprises step 430. In step 410, the pre-process 4 may automatically store the determined performance metrics as pre-stored performance metrics.

The pre-process 4 for analyzing the resources in the network ends at step 435.

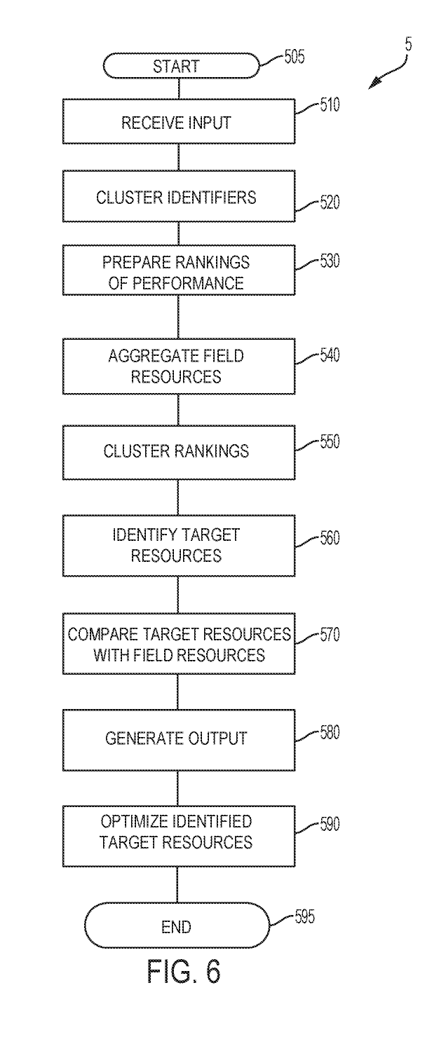

FIG. 6 shows a flow chart of a process 5 for analyzing resources in a network according to an embodiment of the present invention.

The process 5 for analyzing the resources in the network starts at step 505.

Following step 505, the process 5 comprises step 510. In step 510, the process 5 may receive an input comprising one or more identifiers to one or more target resources in the network, and one or more values for one or more performance metrics relevant to the one or more target resources. The one or more identifiers may comprise at least one of a universal resource locator, a domain name and a subdomain name. The one or more target resources may comprise at least one of a target webpage, a target software application, a target app and a target app store. The one or more performance metrics may comprise at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate. The one or more performance metrics may comprise one or more context-related performance metrics relating to one or more contextual networks.

Following step 510, the process 5 may comprise step 520. In step 520, the process 5 may automatically cluster two or more identifiers of the one or more identifiers into clustered identifiers based on the one or more performance metrics.

Following step 510 or 520, the process 5 comprises step 530. In step 530, the process 5 may automatically prepare one or more rankings of performance for the one or more target resources, and one or more field resources based on the one or more performance metrics. The one or more field resources may comprise at least one of a field webpage, a field software application, a field app and a field app store. Preparing the one or more rankings may comprise averaging the pre-stored performance metrics such as weighting the pre-stored performance metrics. The one or more rankings may relate to one or more subnetworks.

Following step 530, the process 5 may comprise step 540. In step 540, the process 5 may automatically aggregate the one or more field resources from one or more resources based on the one or more target resources.

Following step 540, the process 5 may comprise step 550. In step 550, the process 5 may automatically cluster two or more rankings of the prepared one or more rankings into a clustered ranking.

Following step 540 or 550, the process 5 comprises step 560. In step 560, the process 5 may automatically identify, from one or more target resources, one or more identified target resources having a performance potential higher than remaining target resources of the one or more target resources.

Following step 560, the process 5 may comprise step 570. In step 570, the process 5 may automatically compare the one or more identified target resources with the one or more field resources.

Following step 560 or 570, the process 5 may comprise step 580. In step 580, the process 5 may automatically generate an output comprising the one or more identified target resources.

Following step 560, 570 or 580, the process 5 may comprise step 590. In step 590, the process 5 may optimize the one or more identified target resources.

The process 5 for analyzing the resources in the network ends at step 595.

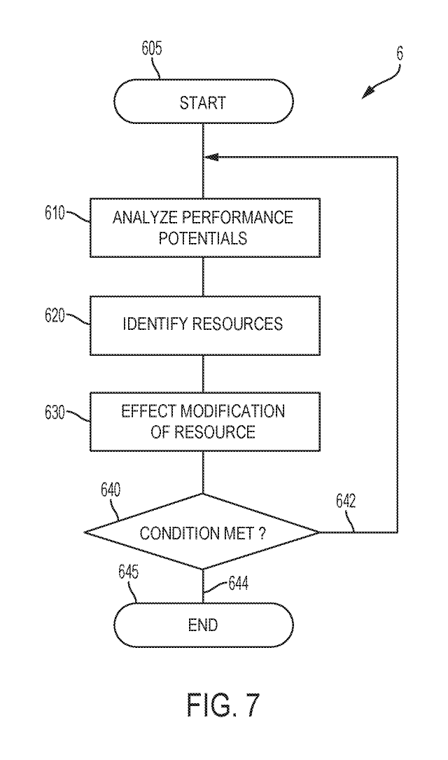

FIG. 7 shows a flow chart of a process 6 for managing resources in a network according to an embodiment of the present invention.

The process 6 for managing the resources in the network starts at step 605.

Following step 605, the process 6 comprises step 610. In step 610, the process 6 may automatically analyze performance potentials of the resources based on performance metrics of the resources.

Following step 610, the process 6 comprises step 620. In step 620, the process 6 may automatically identifies a resource having a highest performance potential of the performance potentials.

Following step 620, the process 6 comprises step 630. In step 630, the process 6 may, for increasing performance metrics of the identified resource, effect modification of the identified resource.

Following step 630, the process 6 may comprise step 640. In step 640, the process 6 may, if a condition is not met 642, continue at step 610 and, thus, repeat said analyzing, identifying and effecting. The process 6 may, if the condition is met 644, continue at step 645. The condition may, for example, be defined by a number of resources to be identified and affected, a level of highest performance potential to be achieved, or a pre-determined amount of credit such as time credit or usage credit to be used up.

The process 6 for managing the resources in the network ends at step 645.

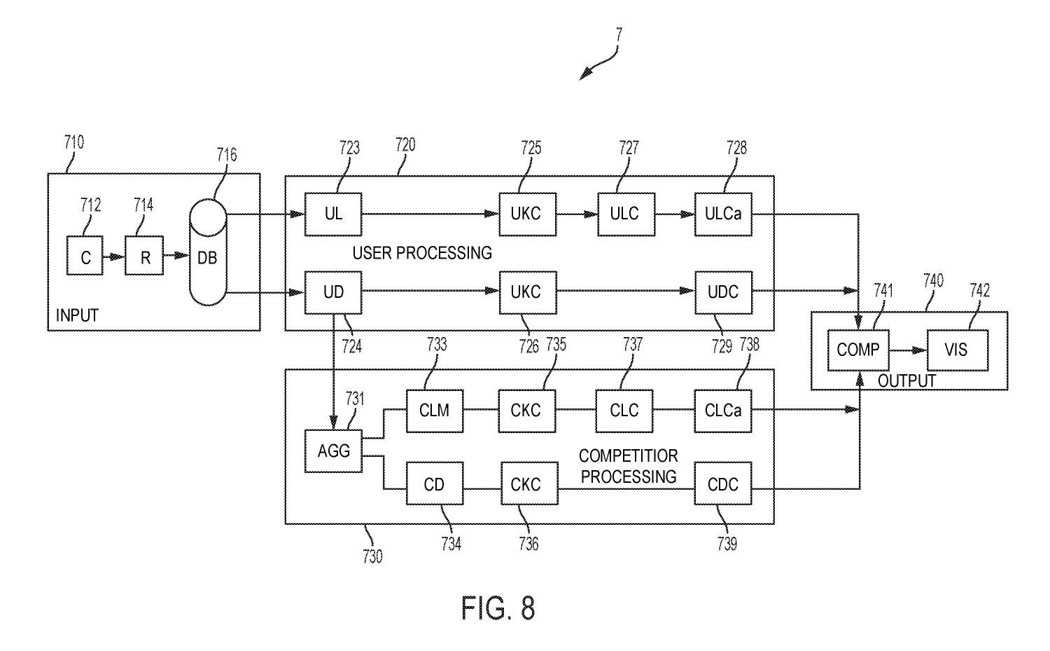

FIG. 8 shows a flow chart of another process 7 for analyzing resources in a network according to another embodiment of the present invention.

The other process 7 for analyzing resources in the network comprises an input module 710, a user processing module 720 coupled to the input module 710, a competitor processing module 730 coupled to the input module 710, and an output module 740 coupled to the user processing module 720 and the competitor processing module 730.

The input module 710 comprises a crawler module 712, a ranking module 714 coupled to the crawler module 712 and a data base module 716 coupled to the ranking module 714.

The user processing module 720 comprises a user locator module 723 coupled to the data base module 716 of the input module 710, a user keyword cluster module 725 coupled to the user locator module 723, a user locator cluster module 727 coupled to the user keyword cluster module 725, a user locator calculation module 728 coupled to the user locator cluster module 727, a user domain module 724 coupled to the data base module 716 of the input module 710, a user keyword cluster module 726 coupled to the user domain module 724, and a user domain calculation module 729 coupled to the user keyword cluster module 726.

The competitor processing module 730 comprises an aggregation module 731 coupled to the user locator module 723 and the user domain module 724 of the user processing module 720, a competitor locator module 733 coupled to the aggregation module 731, a competitor keyword cluster module 735 coupled to the competitor locator module 733, a competitor locator cluster module 737 coupled to the competitor keyword cluster module 735, a competitor locator calculation module 738 coupled to the competitor locator cluster module 737, a competitor domain module 734 coupled to the aggregation module 731, a competitor keyword cluster module 736 coupled to the competitor domain module 734, and a competitor domain calculation module 739 coupled to the competitor keyword cluster module 736.

The output module 740 comprises a comparison module 741 coupled to the user locator calculation module 728 and the user domain calculation module 729 of the user processing module 720 and the competitor locator calculation module 738 and the competitor domain calculation module 739 of the competitor processing module 730, and a visualization module 742 coupled to the comparison module 741.

Referring to the input module 710, the crawler module 712 crawls a network, i. e. explores resources in the network, and acquires contents from one or more resources in the network. The crawler module 712 may automatically crawl the network. Alternatively, the crawler module 712 may receive, from a user, one or more locators, one or more domains or one or more subnetworks, identifying one or more resources. The ranking module 714 extracts, based on one or more keywords, rankings from the one or more resources. The ranking module 714 uses performance metrics such as rankings for particular keywords like “home” or “house”, numbers of social signals to get most relevant resources in the network or subnetwork. For example, a user may enter a keyword in a search engine and receive a plurality of URLs becoming the performance metrics. The data base module 716 stores the contents and rankings of the resources, or the keywords and so. It may store additional data such as traffic, search volume, CPC.

Referring to the user processing module 720, the user locator module 723 receives, from the user, one or more locators, or the user domain module 724 receives one or more domains, identifying one or more resources being of interest to the user, i. e. user resources or target resources. Thus, one or more resources in the data base module 716 may serve as user resources. The additional data may be mapped to the user resources, i. e. user locators or user domains. For example, amounts of traffic may be mapped on the competitor locators by their ranking position.

For one or more user locators, the user keyword cluster module 725 may cluster additional keywords on the user locators. Thus, amounts of traffic relating to the additional keywords may also be mapped on the user locators. The user locator cluster module 727 may cluster locators for keywords being similar to each other, like “house” or “houses”. Locators may belong to one or more clusters. The clusters may, for example, be named after a keyword having a search volume being higher than the search volumes of the other keywords in the cluster. The user locator calculation module 728 calculates present performances or performance potentials, i. e. the potentials to achieve a better position in the search engine results, of one or more user locators based on, for example, their keyword search volumes, amounts of traffic and ranking positions. With reference to FIG. 3, a most relevant user locator assigned to the first individual organic search result section 235-11 on the first SERP 200-1 has no performance potential to achieve an even better position.

For one or more user domains, the user keyword cluster module 726 may cluster additional keywords on the user domains. As described with reference to the user keyword cluster module 725, amounts of traffic relating to the additional keywords may also be mapped on the user domains. The user domain calculation module 729 calculates present performances or performance potentials, i. e. the potentials to achieve a better position in the search engine results, of one or more user domains based on, for example, their keyword search volumes, amounts of traffic and ranking positions. With reference to FIG. 3, a most relevant user domain assigned to the first individual organic search result section 235-11 on the first SERP 200-1 has no performance potential to achieve an even better position.

Referring to the competitor processing module 730, the aggregation module 731 aggregates, from the user resources, i. e. user locators or user domains, one or more competitors being relevant to the user resources.

The competitor locator module 733 receives, from the aggregation module 731, one or more locators, or the competitor domain module 734 receives one or more domains, identifying one or more resources of the one or more competitors, i. e. competitor resources or field resources. Thus, one or more resources in the data base module 716 may serve as competitor resources. The additional data may be mapped to the competitor resources, i. e. competitor locators or competitor domains. For example, amounts of traffic may be mapped on the competitor locators by their ranking position.

For one or more competitor locators, the competitor keyword cluster module 735 may cluster additional keywords on the competitor locators. As described with reference to the user keyword cluster module 725, amounts of traffic relating to the additional keywords may also be mapped on the competitor locators. The competitor locator cluster module 737 may cluster locators for keywords being similar to each other. Locators may belong to one or more clusters. The clusters may, for example, be named after a keyword having a search volume being higher than the search volumes of the other keywords in the cluster. The competitor locator calculation module 738 calculates present performances or performance potentials of one or more competitor locators based on, for example, their keyword search volumes, amounts of traffic and ranking positions. With reference to FIG. 3, a most relevant competitor locator assigned to the first individual organic search result section 235-11 on the first SERP 200-1 has no performance potential to achieve an even better position.

For one or more competitor domains, the competitor keyword cluster module 736 may cluster additional keywords on the competitor domains. Thus, amounts of traffic relating to the additional keywords may also be mapped on the competitor domains. The competitor domain calculation module 739 calculates present performances or performance potentials of one or more competitor domains based on, for example, their keyword search volumes, amounts of traffic and ranking positions. With reference to FIG. 3, a most relevant competitor domain assigned to the first individual organic search result section 235-11 on the first SERP 200-1 has no performance potential to achieve an even better position.

Referring to the output module 740, the comparison module 741 receives the present performances or performance potentials of one or more user locators or user domains and one or more competitor locators or competitor domains, and compares same to identify one or more user locators or user domains having the highest present performance or highest performance potential. The visualization module 742 shows the results of the comparison. The user can easily and quickly perceive which user locators or user domains have the highest performance or performance potential and, thus, focus attention and work on these user locators or user domains, regardless whether the user has hundreds, thousands or even millions of resources in the network.

The embodiments described herein are exemplary and explanatory, and are not restrictive of the invention as defined in the claims.

1. A computer-implemented method of analyzing resources in a network, the method comprising:
acquiring contents from one or more resources in the network;
determining performance metrics characterizing each of the one or more resources in the network;
storing the performance metrics;
at an analyzer executing on one or more computing devices, receiving an input comprising:
one or more identifiers to one or more target resources in the network, and
one or more values for the one or more performance metrics relevant to the one or more target resources;
automatically, with the analyzer using pre-stored performance metrics, preparing one or more rankings of performance for the one or more target resources, and one or more field resources based on the one or more performance metrics;
automatically, with an aggregator executing on one or more computing devices and coupled to the analyzer, aggregating the one or more field resources from one or more resources based on the one or more target resources;
automatically, with the analyzer using the prepared one or more rankings, identifying, from one or more target resources, one or more identified target resources having a performance potential higher than remaining target resources of the one or more target resources;
comparing the one or more identified target resources with the one or more field resources; and
modifying the one or more identified target resources based on the comparison.

2. The method of claim 1, wherein:
the one or more identifiers comprise at least one of a universal resource locator, a domain name and a subdomain name.

3. The method of claim 1, wherein:
the one or more target resources comprise at least one of a target webpage, a target software application, a target application and a target application store.

4. The method of claim 1, wherein:
the one or more field resources comprise at least one of a field webpage, a field software application, a field application and a field application store.

5. (canceled)

6. The method of claim 1, wherein:
the one or more performance metrics comprise:
at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate; or
the one or more performance metrics comprise one or more context-related performance metrics relating to one or more contextual networks.

7. The method of claim 1, wherein:
preparing the one or more rankings comprises:
averaging the pre-stored performance metrics; or
weighting the pre-stored performance metrics.

8. A system for analyzing resources in a network, the system comprising:
an analyzer, when executing on one or more computing devices:
being suitable for performing the method of claim 1.

9. A computing device for analyzing resources in a network, the computing device comprising:
one or more processors, configured to perform operations; and
a memory, coupled to the one or more processors and comprising:
a crawler, when executing on the one or more processors:
acquiring contents from one or more resources in the networks;
a determiner, when executing on the one or more processors:
determining performance metrics characterizing each of the one or more resources in the network;
a data base to store the performance metrics;
an analyzer, when executing on the one or more processors:
receiving an input comprising:
one or more identifiers to one or more target resources in the network, and
one or more values for one or more performance metrics relevant to the one or more target resources;
automatically, using pre-stored performance metrics, preparing one or more rankings of performance for the one or more target resources, and one or more field resources based on the one or more performance metrics;
automatically, with an aggregator executing on the one or more processors and coupled to the analyzer, aggregating the one or more field resources from one or more resources based on the one or more target resources;
automatically, using the prepared one or more rankings, identifying, from one or more target resources, one or more identified target resources having a performance potential higher than remaining target resources of the one or more target resources;
comparing the one or more identified target resources with the one or more field resources; and
a manager, when executing on the one or more processors:
modifying the one or more identified target resources based on the comparison.

10. The computing device of claim 9, wherein:
the one or more identifiers comprise at least one of a universal resource locator, a domain name and a subdomain name.

11. The computing device of claim 9, wherein:
the one or more target resources comprise at least one of a target webpage, a target software application, a target application and a target application store.

12. The computing device of claim 9, wherein:
the one or more field resources comprise at least one of a field webpage, a field software application, a field application and a field application store.

13. (canceled)

14. The computing device of claim 9, wherein:
the one or more performance metrics comprise:
at least one of a keyword, a search volume of the keyword, a cost-per-click of the keyword, a traffic volume of a resource, a traffic speed of the resource, a volume of social signals of the resource, a number of backlinks to the resource, a rating of the resource, a search-engine-optimization value of the resource, a bounce rate and a click-through rate; or
the one or more performance metrics comprise one or more context-related performance metrics relating to one or more contextual networks.

15. The computing device of claim 9, wherein:
preparing the one or more rankings comprises:
averaging the pre-stored performance metrics; or
weighting the pre-stored performance metrics.

16. A non-transitory computer-readable storage medium comprising instructions causing a system to perform operations for analyzing resources in a network, the operations being suitable for performing the method of claim 1.

17. A computer-implemented method of managing resources in a network, the method comprising:
automatically analyzing performance potentials of the resources based on performance metrics of the resources;
automatically identifying a resource having a highest performance potential of the performance potentials;
for increasing performance metrics of the identified resource, effecting modification of the identified resource;
automatically determining whether a condition is met by the identified resource; and
repeating the analyzing step, the identifying step, and the effecting modification step if the condition is not met.

18. A system of managing resources in a network, the system comprising:
a manager, when executing on one or more computing devices:
being configured to perform the method of claim 17.

19. A computing device for managing resources in a network, the computing device comprising:
one or more processors, configured to perform operations; and
a memory, coupled to the one or more processors and comprising:
a manager, when executing the one or more processors:
automatically analyzing performance potentials of the resources based on performance metrics of the resources;
automatically identifying a resource having a highest performance potential of the performance potentials;
for increasing performance metrics of the identified resource, effecting modification of the identified resource;
automatically determining whether a condition is met by the identified resource; and
repeating the analyzing step, the identifying step, and the effecting modification step if the condition is not met.

20. A non-transitory computer-readable storage medium comprising instructions causing a system to perform operations for analyzing resources in a network, the operations being suitable for performing the method of claim 17.
